(19) United States
(12) Patent Application Publication
(10) Pub. No.: US 2007/0033305 A1
(43) Pub. Date: Feb. 8, 2007

(54) Method or apparatus for transferring data

(75) Inventor: Ajit Malaviya, Karnataka (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P., Houston, TX (US)

(21) Appl. No.: 11/490,123

(22) Filed: Jul. 21, 2006

(30) Foreign Application Priority Data
Aug. 8, 2005 (IN) IN1100/CHE/2005

(51) Int. Cl. G06F 5/00

(52) U.S. Cl. 710/52

(57) ABSTRACT

A method and apparatus is disclosed for transferring data in a processor in which if data destined for an application buffer is not read or modified by an application program then it is saved to storage from the input or read buffer.

### BACKGROUND OF THE INVENTION

Application programs run on an operating system of a computer. When an application program requires data for processing, a request is sent to the operating system to retrieve the required data. The data is copied from a source file in storage such as a disk drive or other persistent storage device, via one or more input/output (I/O) buffers, into a buffer of the processor which is assigned to the application program. The application program can then read or modify the data in the buffer. Once the processing of the data or a part of the data is complete, the processed data is stored by writing it to a destination file in storage.

Many such file operations involve reading a file and writing it in another location without making any modifications to the original data. In this case, operating system and processor resources are needlessly occupied in transferring data to and from storage. Some operating systems implement special mechanisms to make this process more efficient. However, benefiting from such mechanisms can require modifications to applications and utilities which are based on standard interfaces.

### BRIEF DESCRIPTION OF THE DRAWINGS

Embodiments of the invention will now be described, by way of example only, with reference to the accompanying drawings in which:

FIG. 1 is a schematic illustration of a computer system; and

FIGS. 2 and 3 are flow charts illustrating processing carried out by the computer system of FIG. 1.

### DETAILED DESCRIPTION OF EMBODIMENTS

There will be described a method transferring data for use by a processor, the method comprising the steps of:
a) assigning an input data store for holding input data for subsequent processing, an output data store for holding processed data and a current data store for holding data for use by the processor;
b) transferring data for use by the processor from storage into the input data store;
c) monitoring the current data store for a read access by the processor; and
d) if no read access is detected for the current data store then, in response to a write operation on the current data store, saving the contents of the input data store to storage.

If in step c) a read access is detected then the data may be copied from the input data store to the current data store and, in response to a subsequent write operation on the current data store, the contents of the current data store copied to the output data store. Access to the current data store may be removed and the read access detected when an access fault is generated for the current data store. Once the data is transferred into the input data store then the store may be marked as busy or in-use.

Steps c) and d) may be triggered by a flag associated with the file from which the data is transferred. The data may be processed under the control of one or more application programs running on the processor. The input data store may be provided by one or more I/O read buffers, the output data store may be provided by one or more I/O write buffers and the current data store may be provided by one or more application buffers.

There will also be described apparatus for transferring data for use by a processor, the apparatus being operable to assign an input data store for holding input data for subsequent processing, an output data store for holding processed data and a current data store for holding data for use by the processor; transfer data for use by the processor from storage into the input data store; monitor the current data store for a read access by the processor; and if no read access is detected for the current data store then, in response to a write operation on the current data store, to save the contents of the input data store to storage.

Further embodiments provide a computer processor operable to transfer data from a source file into a read buffer for use by an application program; assign an application buffer to the application program; deny access by the application program to the application buffer; and if the application program issues a write on the application buffer without first having attempted to read the buffer then to save the data from the read buffer to a destination file.

An embodiment provides a method of transferring data from storage for use by an application program, the method comprising the steps of:
a) transfer data from storage into an input buffer;
b) setting the permissions of an application buffer for use by the application program when processing the data, the permissions resulting in an access fault if the application accesses the application buffer
c) receiving an instruction from the application program to save the contents of the application buffer to storage;
d) if no access fault has been received for the application buffer then in response to the instruction, saving the contents of the input buffer to storage.

In step b) the permissions may be set so as to bar access to the application buffer and the access fault is a read fault. The method may comprise the further step of:
e) if a read fault is generated for the application buffer then copying the data into the application buffer and in response to the instruction, saving the contents of the application buffer to storage. In step a) the data may be copied into the application buffer and in step b) the permissions may be set to read only and the access fault may be a write fault. The method may comprise the further step of: e) if a write fault is generated for the application buffer then, in response to the instruction, saving the contents of the application buffer to storage.

Some embodiments provide a program or a group of programs arranged to enable a programmable device or a group of programmable devices to carry out a method transferring data for use by a processor, the method comprising the steps of:
a) assigning an input data store for holding input data for subsequent processing, an output data store for holding processed data and a current data store for holding data for use by the processor;
b) transferring data for use by the processor from storage into the input data store;
c) monitoring the current data store for a read access by the processor; and
d) if no read access is detected for the current data store then, in response to a write operation on the current data store, saving the contents of the input data store to storage.

Some embodiments provide a program or a group of programs arranged to enable a programmable device or a group of programmable devices to provide apparatus for transferring data for use by a processor, the apparatus being operable to assign an input data store for holding input data for subsequent processing, an output data store for holding processed data and a current data store for holding data for use by the processor; transfer data for use by the processor from storage into the input data store; monitor the current data store for a read access by the processor; and if no read access is detected for the current data store then, in response to a write operation on the current data store, to save the contents of the input data store to storage.

Some embodiments provide a program or a group of programs arranged to enable a programmable device or a group of programmable devices to provide apparatus for transferring data for use by a processor, the apparatus being operable to transfer data for use by the processor from storage into the input data store and copying the data into the current data store; monitor the current data store for a write access by the processor; and if no write access is detected for the current data store then, in response to a write operation on the current data store, to save the contents of the input data store to a file in storage.

Some embodiments provide a program or a group of programs arranged to enable a programmable device or a group of programmable devices to carry out a method of transferring data from storage for use by an application program, the method comprising the steps of:
a) transfer data from storage into an input buffer;
b) setting the permissions of an application buffer for use by the application program when processing the data, the permissions resulting in an access fault if the application accesses the application buffer
c) receiving an instruction from the application program to save the contents of the application buffer to storage;
d) if no access fault has been received for the application buffer then in response to the instruction, saving the contents of the input buffer to storage.

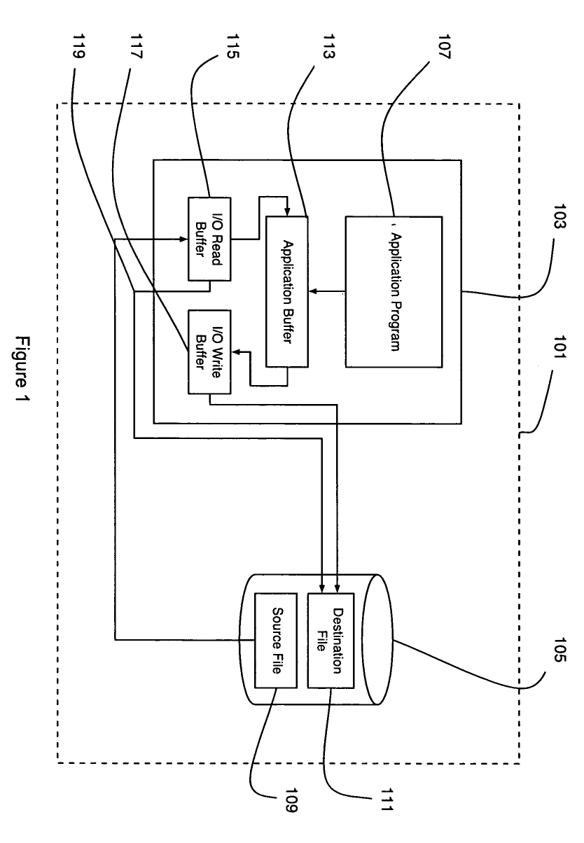

With reference to FIG. 1, a computer 101 comprises a processor 103 and a storage device 105 in the form of a disk drive. The processor runs an operating system (OS) (not shown) such as Linux which enables an application program 107 to run on the processor and to process data held on the storage device 105. The OS can run in two modes: a normal mode and an optimized mode.

In the normal mode, when the application program requires data from a source file 109 stored on the storage device 105, the program first opens the file for reading and receives a file descriptor (FWR) in return. The application then opens a destination file 111 to which to write the results of its processing and receives a further file descriptor (FDW). The file descriptors (FDR, FDW) provide the physical addresses of the files on the storage device 105.

The application program 107 is allocated a buffer (BUF) 113 for holding the data from the opened file 109 which it is processing. When the program issues a read instruction of a number of bytes on the buffer 113, the requested data is transferred, under the control of the kernel, from the source file 109 on the disk drive to an input/out read buffer (IOBR) 115 on the processor 103. From the IOBR the data is then copied into the application buffer (BUF) 113. Once the requested data is in the application buffer it can be read and modified by the application program. When the application program 107 issues a write operation of a number of bytes of the data in the buffer (BUF) the allocated contents of the BUF are copied into an input/output write buffer (IOBW) 117. From the IOBW the data is transferred, under the control of the kernel, to the destination file 111 on the storage device 105.

In the optimized mode, the kernel carries out further steps which can reduce the number of copy operations carried out by the processor 103 when transferring data between files on the storage device and the application buffer. The optimized mode is set by a system administrator. In the optimized mode, when providing data requested by an application program, the kernel only copies the data from the IOBR into the application buffer if the application program attempts to read the data from the application buffer. If the buffer is not read before it is written back to disk then the data from the read buffer IOBR is saved to disk as indicated by arrow 119 in FIG. 1. If however the application attempts to read the application buffer then the data in the read buffer IOBR is copied in the normal way as described above. In other words, data is only copied into the application buffer if it is actually used by the program, otherwise when the application issues a write on its buffer, data is transferred straight from the read buffer IOBR to storage.

In the optimized mode, once data has been transferred into the read buffer IOBR, the application buffer is marked as “no access” and the buffer IOBR is marked as busy or in use. Marking the buffer as “no access” enables any read by the application on its buffer to be detected or monitored by the kernel as it will generate an access fault for that buffer. Denying access to the read buffer IOBR preserves its contents.

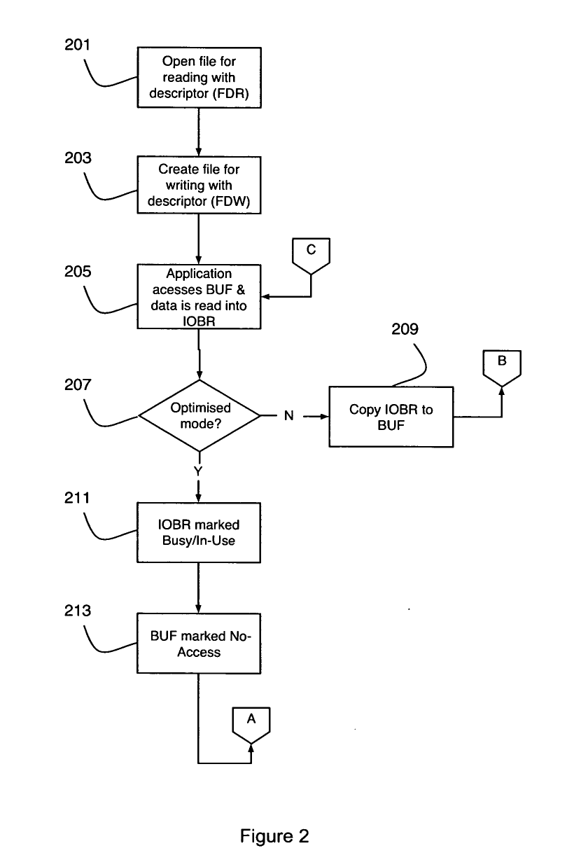

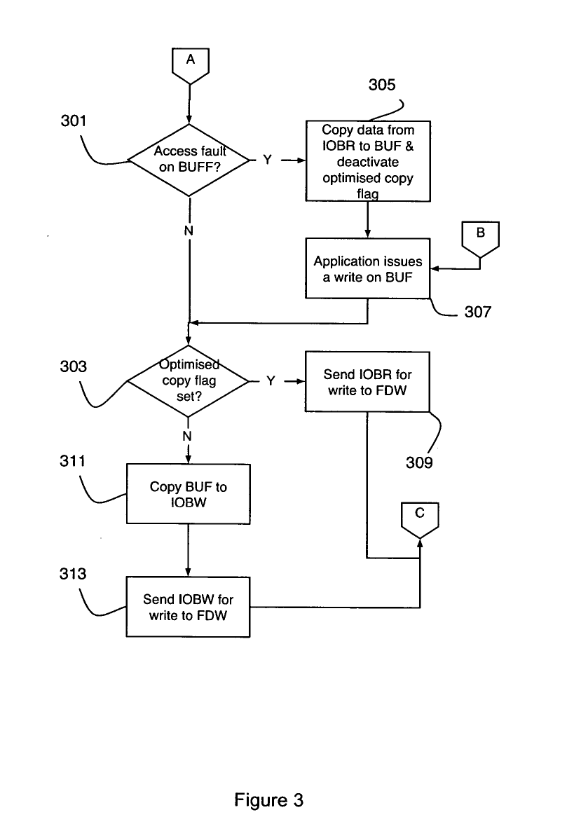

The processing carried out by the kernel in the normal and optimized modes will now be described in further detail with reference to FIG. 2 and FIG. 3. At step 201, the application opens the source file 109 for writing and receives the file descriptor FDR. Processing then moves to step 203 where the application opens a destination file 111 for writing to which has the file descriptor FDW. Processing then moves to step 205 where the application is allocated an application buffer 113 by the kernel. The application then issues a read request for a number of bytes from the source file and that data is transferred into the read buffer IOBR 105. Processing then moves to step 207.

At step 207, the kernel checks whether it has been set to optimized or normal mode. If the kernel is operating in normal mode then processing moves to step 209 where the contents of the read buffer IOBR are copied into the application buffer and processing moves to step 307 in the flow chart of FIG. 3 and continues as described later. If at step 207 the kernel is operating in optimized mode then processing moves to step 211 where the read buffer IOBR is marked as busy thus preserving its contents and an optimized copy flag is activated associated with the application buffer. Processing then moves to step 213 where access is barred to the application buffer BUF and processing moves to step 301 in the flow chart of FIG. 3.

Processing continues from step 301 either as a result of an access fault being detected by the kernel on the application buffer or by the application issuing a write instruction on the application buffer. If at step 301 the application issues a write instruction then processing moves to step 303. If an access fault is detected at step 301 then processing moves to step 307 where the contents of the read buffer IOBR are copied to the application buffer and the optimized copy flag for the application buffer is deactivated. Processing then moves to step 307 and waits for a write to be issued on the application buffer before moving to step 303.

At step 303, if the optimized copy flag is still active then processing moves to step 309 where the contents of the read buffer IOBR 115 are written to the destination file 111 and processing returns to step 205. If at step 303 the optimized copy flag was not active as processing passed though step 209 or has been deactivated when processing passed though step 305 then processing moves to step 311 where the contents of the application buffer 113 are written to the write buffer IOBW 117 before being written to the destination file 111 at step 313. Processing then returns to step 205 to await the next read issued by the application program. If at step 303 the optimized copy flag is activated then the contents of the read buffer IOBR are transferred directly to the destination file 111 and processing returns to step 205 as described above.

In the above arrangement, if the application program does not attempt to access the data in the application buffer then the optimized mode saves two buffer copies within the processor when compared to the normal mode of operation. In cases where data has just to be copied from one file (or device) to another, the optimizations can be applied implicitly by the kernel, without the application being aware of the modified operation. This is an advantage in cases where it is not possible to rebuild or rewrite the applications and is useful for systems designed for a wide variety of operating systems where it may be difficult to utilize special interfaces provided by an OS.

In another embodiment, the buffers IOBR, IOBW, BUF and the I/O operation ranges are of different sizes. The sizes of I/O buffers can be system and file system dependent, while BUF size can be application dependent. Additional structures are added to enable such fragmented I/O to be tracked. These structures are used to track the extent to which the I/O buffers IOBR, IOBW have been read or written to and also verification that the same application buffer BUF is used for the operations. This enables fragmented I/O to be handled while carrying out the processing according to the optimized or normal modes as described above with reference to FIG. 2 and FIG. 3. The following data is maintained in the headers for the relevant buffers:

For the I/O buffers IOBR, IOBW:
Buffer_size—size of the buffer in bytes;
Buffer_read—number of bytes that have been read;
Buffer_write—number of bytes that have been written;
Buffer_changed—True if the buffer has been modified; and
Buffer_pointer—points to the address of the application buffer used.

For the application buffer BUF:
Read_offset—offset from where the last read was done;
Read_size—size of last read; and
Buffer_changed—True if the buffer has been modified.

When the application program issues a read, it passes the input file descriptor (FDR), the buffer (BUF) and a read size (RDSZ) as arguments to the kernel. In response to this the kernel retrieves the file offset for the file from an internal data structure indexed by file descriptor and processes the read as set out in the following pseudo code:

Temp_var = IOBR[i]−>Buffer_read + RDSZ
IF (Temp_var > IOBR[i]−>Buffer_size)
IOBR[i]−>Buffer_read = IOBR[i]−>Buffer_size
ELSE IOBR[i]−>Buffer_read = Temp_var
Set BUF permissions for No Access
IOBR[i]−>Buffer_pointer = BUF

In this code routine, if the temporary variable Temp_var>IOBR[i]—>Buffer_size, the kernel gets the next buffer IOBR[i+l] and update its fields until the requested RDSZ bytes are processed, at which point the kernel returns from read. If BUF is written to any time after the read and before a subsequent write on the application buffer, the Buffer_changed flag will be set to true, which will deactivate the optimized copy flag.

When the application issues a write operation on the application buffer, it passes the destination file descriptor (FDW), the buffer (BUF) and the write size (WRSZ) as arguments to the kernel. The kernel retrieves the file offset for the destination file from an internal data structure indexed by the file descriptor and also gets the relevant 10 Buffer, IOBW[i] that corresponds to this offset. The kernel then carries out the processing set out below in pseudo code:

Temp_var = IOBW[i]−>Buffer_write + WRSZ
IF Temp_var > IOBW[i]−>Buffer_size
IOBW[i]−>Buffer_write = IOBW[i]−>Buffer_size
ELSE IOBW[i]−>Buffer_write = Temp_var
IF BUF−>Buffer_changed = True
IOBW[i]−>Buffer_changed = True
IF IOBW[i]−>Buffer_write = IOBW[i]−>Buffer_size
IF IOBW[i]−>Buffer_changed = True
Deactivate Optimized Copy flag
Issue write(IOBR[i])
ELSE Issue write(IOBW[i])

In this code routine, if the variable Temp_var>IOBW[i]->Buffer_size, the kernel continues writing subsequent buffers until the write of WRSZ bytes is complete when the kernel returns from write. If the buffer has been changed then the optimized copy flag is deactivated and a normal copy is carried out rather than an optimized copy.

In some embodiments, in the optimized mode, data is transferred from storage into the read buffer IOBR and then copied into the application buffer BUF which is marked as read only. When the application attempts to read the contents of its application buffer no fault is generated. Only when the application program attempts to change the data in the buffer is a fault generated. In response to the fault, the kernel modifies the permissions to enable the write and deactivates the optimized copy flag. If no write fault is generated for the buffer before the application program issues a write on the buffer then the data from the read buffer IOBR is saved to the destination file in storage. This arrangement reduces the number of copies carried out in the processor by one, if the data in the application buffer remains unchanged.

In another embodiment, the kernel is arranged to monitor the performance of an application program and to dynamically select whether to apply the first technique described above where read faults are detected or the second technique where only write faults are detected. For example if the first technique is adopted for initial processing of the application program but more than half the reads in a predetermined period are not optimized then the kernel may switch to the second technique for the duration of the processing.

In a further embodiment, the file system used for the storage device 105 includes sparse files. A sparse file is a file that does not contain continuous data, but includes gaps or holes in the file where no data is present. The file systems that support sparse files do not allocate disk space for the holes, which conserves disk space. A normal read operation on a hole, however, succeeds, and returns a buffer full of zeros. Thus the fact that a file is sparse is transparent to the application program reading the file. During a normal copy operation, when the holes are read and written, they are converted to a normal file blocks, causing extra disk space to be used.

In this embodiment, each sparse block in the source file is flagged. When the kernel is operating in optimized mode as described above and reads a block from the source file which is flagged as sparse, the read does not result in any I/O operation. A read buffer IOBR is allocated, and marked as sparse. The kernel removes the access permissions for application buffer BUF as described above and the kernel returns from the read operation. If the application issues a write on the application buffer BUF without accessing its contents, the read buffer IOBR is marked for write and the write operation responds to the sparse flag by creating a gap or hole in the destination file. In this way, the sparse nature of the file is maintained if the application makes no change to the data. If the application buffer BUF is accessed or has been written to then write completes in a normal fashion as described above.

Using this approach, the sparse attribute of a file can be maintained across a read and write, and can be replicated at the destination. In cases where a sparse file is being backed up to a storage device such as a tape device, it is possible to convey the sparse nature of a file to the tape, thus enabling full re-creation of the file during a restore operation.

Embodiments may be applied to file streaming systems such as multi media file systems (MMFS) which host video and audio files for streaming download across networks. Such files are usually read from beginning to end in a continuous manner. The data read goes unchanged to a device such as a network interface card (NIC) for transmission to another computer or digital system. This arrangement can be treated as a copy where the destination is a NIC instead of a disk based file and therefore this data transfer process can be optimized. Since the application buffer BUF will be an unchanged copy of read buffer IOBR, it can be directly sent to the NIC, avoiding two extra buffer copies (IOBR to BUF and BUF to IOBW). Thus a MMFS using this approach can implicitly implement a copy optimization to provide an improved throughput.

In a further embodiments, instead of the kernel having a normal and an optimized mode, particular files or applications are marked as being suitable for optimized processing. In another embodiment, when a file system is mounted, a special option is provided that requests that all files residing on that file system be marked for copy optimization. In a further embodiment, an attribute is set on a file that causes it to be marked for copy optimization or when the file is opened, an option is passed to it for copy optimization to be set. In each of these cases, the copy optimization flag is set in the internal file system management data structures and used for subsequent operations.

It will be understood by those skilled in the art that the apparatus that embodies a part or all of the present invention may be a general purpose device having software arranged to provide a part or all of an embodiment of the invention. The device could be single device or a group of devices and the software could be a single program or a set of programs. Furthermore, any or all of the software used to implement the invention can be communicated via suitable transmission or storage means so that the software can be loaded onto one or more devices.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from the spirit or scope of applicant's general inventive concept.

1. A method transferring data for use by a processor, the method comprising the steps of:
a) assigning an input data store for holding input data for subsequent processing, an output data store for holding processed data and a current data store for holding data for use by said processor;
b) transferring data for use by said processor from storage into said input data store;
c) monitoring said current data store for a read access by said processor; and
d) if no read access is detected for said current data store then, in response to a write operation on said current data store, saving the contents of said input data store to storage.

2. A method according to claim 1 in which if in step c) a read access is detected then copying said data from said input data store to said current data store and, in response to a subsequent write operation on said current data store, copying the contents of said current data store to said output data store.

3. A method according claim 1 in which access to said current data store is removed and said read access is detected when an access fault is generated for said current data store.

4. A method according to claim 1 in which once said data is transferred into said input data store then said store is marked as busy or in-use.

5. A method according to claim 1 in which steps b), c), and d) are replaced by the following steps:
e) transferring data for use by said processor from storage into said input data store and copying said data into said current data store;
f) monitoring said current data store for a write access by said processor; and
g) if no write access is detected for said current data store then, in response to a write operation on said current data store, saving the contents of said input data store to a file in said storage.

6. A method according to claim 1 in which steps c) and d) are triggered by a flag associated with the file from which said data is transferred.

7. A method according to claim 1 in which said data is processed under the control of one or more application programs running on said processor.

8. A method according to claim 1 in which said input data store is provided by one or more I/O read buffers, said output data store is provided by one or more I/O write buffers and said current data store is provided by one or more application buffers.

9. A method according to claim 1 in which if said input data is from a hole of a sparse file then creating a corresponding hole in said file in said storage.

10. Apparatus for transferring data for use by a processor, the apparatus being operable to:
assign an input data store for holding input data for subsequent processing, an output data store for holding processed data and a current data store for holding data for use by said processor;
transfer data for use by said processor from storage into said input data store;
monitor said current data store for a read access by said processor; and
if no read access is detected for said current data store then, in response to a write operation on said current data store, to save the contents of said input data store to said storage.

11. Apparatus according to claim 10 in which if a read access is detected then said data is copied from said input data store to said current data store and, in response to a subsequent write operation on said current data store, the contents of said current data store are copied to said output data store.

12. Apparatus according to any of claims 10 in which access to said current data store is removed and said read access is detected when an access fault is generated for said current data store.

13. Apparatus according to claim 10 in which said input data store is provided by one or more I/O read buffers, said output data store is provided by one or more I/O write buffers and said current data store is provided by one or more application buffers.

14. Apparatus as claimed in claim 10 for transferring data for use by a processor, wherein the apparatus being operable to:
transfer data for use by said processor from storage into said input data store and copying said data into said current data store;
monitor said current data store for a write access by said processor; and
if no write access is detected for said current data store then, in response to a write operation on said current data store, to save the contents of said input data store to a file in said storage.

15. Apparatus according to claim 10 further operable if said input data is from a hole of a sparse file, to create a corresponding hole in said file in said storage in response to said write operation.

16. A method of transferring data from storage for use by an application program, the method comprising the steps of:
a) transfer data from storage into an input buffer;
b) setting the permissions of an application buffer for use by said application program when processing said data, said permissions resulting in an access fault if said application accesses said application buffer;
c) receiving an instruction from said application program to save the contents of said application buffer to storage; and
d) if no access fault has been received for said application buffer then in response to said instruction, saving the contents of said input buffer to storage.

17. A method according to claim 16 in which in step b) said permissions are set so as to bar access to said application buffer and said access fault is a read fault.

18. A method according to claim 17 comprising the further step of:
e) if a read fault is generated for said application buffer then copying said data into said application buffer and in response to said instruction, saving said contents of said application buffer to storage.

19. A method according to claim 17 in which in step a) said data is copied into said application buffer and in step b) said permissions are set to read only and said access fault is a write fault.

20. A method according to claim 18 comprising the further step of:
e) if a write fault is generated for said application buffer then, in response to said instruction, saving the contents of said application buffer to storage.
